(19) United States
(12) Patent Application Publication
(10) Pub. No.: US 2016/0377029 A1
(43) Pub. Date: Dec. 29, 2016

(54) HELICON YIELD PLASMA ELECTROMAGNETIC RAM-SCRAMJET DRIVE ROCKET ION VECTOR ENGINE

(71) Applicant: Richard H. Lugg, Yarmouth, ME (US)

(72) Inventor: Richard H. Lugg, Yarmouth, ME (US)

(21) Appl. No.: 14/209,858

(22) Filed: Mar. 13, 2014

Related U.S. Application Data
(60) Provisional application No. 61/800,408, filed on Mar. 15, 2013.

(51) Int. Cl. F02K 7/16; F02K 5/00; H02K 44/04; F03H 1/00

(52) U.S. Cl. CPC F02K 7/16; F03H 1/00; F02K 5/00; H02K 44/04; F05D 2200/00; F05D 2220/10; F05D 2220/323; F05D 2220/80

(57) ABSTRACT

HYPERDRIVE receives continuous air breathing assistance from compressed atmospheric air through a high speed magnetically core driven turbine accelerator which resolves around a common flow path tunnel. The tunnel runs from the front to the back of the engine. It is assisted by a series of radial geometric ramjet engines that share the common flow path tunnel for hypersonic exhaust but has separate inlet air from a linear aerospike which governs mass flow of air, velocity of inlet air and pressure to the turbine and/or ramjets, as well as the positioning of the shock wave at the inlet to reduce aerodynamic drag. The ramjet is of hybrid engine design where it can also function as a scramjet, thus a ram-scramjet structure for combustion in a radial configuration about the engine (aft of an electrical compressor), where the common flow path tunnel also serves as a compression tunnel to compress air through a the constantly occurring series of compression shocks entering from and around the aerospike.

### CROSS REFERENCE TO RELATED APPLICATION

This application is a nonprovisional and claims the priority benefit of U.S. provisional patent application Ser. No. 61/800,408 filed Mar. 15, 2013, of the same investor. The content of that application is incorporated herein by reference.

### FIELD OF THE INVENTION

The engine described herein relates generally to ion plasma engines, ramjet engines, scram jet engines, turbine engines, and ion plasma helicon drive engines, derivatives thereof, their operating modes, and the distinction in the invention, of those practiced in the art, to the novelty and uniqueness of a particular hybrid space engine design, in of the invention, that incorporates all four types of engine cycles.

### BACKGROUND OF THE INVENTION

Even before the first Lunar landing on the moon propulsion experts and scientists were studying the benefits of single stage to orbit combined cycle air breather and rocket based propulsion systems for horizontal take off launch vehicles, including plasma rockets. Affordable, reliable endo- and exoatmospheric transportation, for both the military and commercial sectors, continues to grow in importance as the world grows smaller and space exploration and exploitation increasingly impact our daily lives. There has yet to be designed, engineered, tested and built for flight for hypersonic atmospheric and space travel a single effective propulsion system; there remains a dire need to accomplish this for the future and furtherance of earth atmosphere and space travel and the future of human kind.

Gas jet turbines developed since the mid 1940s, and subsequent gas turbines in the 1970s are effective for subsonic fixed wing flight to transport the earth masses over considerable distances in the earths atmosphere. These gas turbine machine propulsion engines require the considerable oxygen content up to altitudes of 50,000 feet to operate effectively burning kerosene based hydrocarbon fuels, but are limited to relatively low speeds of Mach 0.85. These turbines compress air mechanically with a complex system of blades, raising pressure so to as to combust kerosene at high temperatures and produce significant amounts of propulsive force measured in thrust to weight ratios of 7:1. This all occurs at subsonic speeds, and under the speed of sound, Mach 1.0. Variations of these turbine designs, but still mechanically compressing air, may have lower bypass air, more compressor stages with higher operating and combustion temperatures, and are capable of sustaining speeds for air vehicles in the mach 2.4-3.0 range. Beyond these speeds it is difficult for these engine designs with mechanical rotating compressor machinery to compress air at faster speeds and still sustain combustion along with the potential deleterious effects of aerothermodynamic drag. Subsequently, these air breathing engines require assistance to further compress air and thus use “ramair” to enhance compression at speeds over Mach 3.0, with operating envelopes to Mach 3.3. The J58 was an engine of this designation which was able to sustain and produce thrust for these speeds in aircraft such as the SR-71 Blackbird.

Improved propulsion technology to achieve greater speeds as air breathers had to be designed where there were to be no mechanical limitations upon materials such as with rotating compressor blades and thus mechanical loading and thermodynamic factors from compressor heating. The upper hypersonic regimes (Mach >10.0) is covered by scramjets, a ramjet with supersonic combustion. Turbocomponents become obsolete since the multi-shock pre-compression inlets already provide sufficiently high pressure ratios. Scramjet engine designs which compress air supersonically via a compression component is achieved by the air entering the inlet at Mach 4.5 roughly and higher, and being compressed by an ever restricting throat (or tunnel) down to a point of combustion. Airflow is moving so last that residence time to achieve combustion, on the order of micro seconds, has been problematic for decades for scramjet designers. Subsequently, to attenuate flow speeds in the combustor, cavity design to produce non-laminar flow and swirl has been introduced in scramjet designs, but to the negative effect that inlet-unstart becomes prevalent (the engine stalls). Work in the area of electromagnetics at the point in front of the cavity to sustain vortex swirl and disruptive eddy current flow to sustain residence time has been tried, but not without slowing combustion flow, hence effecting back pressure at the exhaust and subsequent shock train discontinuity which is measured and controlled by specific inlet design. There is future potential of hybrid electromagnetics and plasma flow control and plasma thrust, to sustain combustion, but it is thought that to have a true measured effect on residence time, it must occur in the combustor itself, rather than the approach to it.

The amount of energy to achieve 3ynchronous stage stage-to-orbit above the earth is on the order of 2,000,000 pounds of thrust, lifting seven humans vertically off a launch pad using liquid propellant fuel as in liquid hydrogen, and oxygen. This is basically an enormous waste of energy as the number of pounds of propellant to generate a pound of thrust is vastly inefficient with the problem being compounded by a vertical take-off launch vehicle, such as the space shuttle. For single stage to orbit vehicle design a horizontal take-off and landing air vehicle is a lot more effective in terms of propulsive efficiency and reusability (and use of existing airports for infrastructure logistics) but there remains no single propulsion system that can achieve this mission type that is not an amalgamation of numerous other engine types, or cross over in flight regimes becomes non-existent; i.e high velocity turbojet to Mach 3.5, must then cross the gap to Mach 4.5 for a scramjet, then must transition to very low density oxygen atmosphere as in altitudes to transition to low earth orbit at 80 to 100 Km, where air-breathers cannot operate. HYPERDRIVE (helicon yield plasma electromagnetic ram-scramjet drive radial scramjet engine) the answer to this problem. The invention and primary embodiment is a single propulsion system that will operate from runway as an air breathing hydrocarbon combustion turbine engine with horizontal take-off capability for a space vehicle to the complete transition to a non-air breathing hypersonic ram-rocket scramjet hybrid drive space engine.

### SUMMARY

HYPERDRIVE receives continuous air breathing assistance from compressed atmospheric air through a high speed magnetically core driven turbine accelerator which revolves around a common flow path tunnel. The tunnel runs from the front to the back of the engine. It is assisted by a series of radial geometric ramjet engines that share the common flow path tunnel for hypersonic exhaust but has separate inlet air from a linear aerospike which governs mass flow of air, velocity of inlet air and pressure to the turbine and/or ramjets, as well as the positioning of the shock wave at the inlet to reduce aerodynamic drag. The ramjet is of hybrid engine design where it can also function as a scramjet, thus a ram-scramjet structure for combustion in a radial configuration about the engine (aft of an electrical compressor), where the common flow path tunnel also serves as a compression tunnel to compress air through a the constantly occurring series of compression shocks entering from and around the aerospike. The engine offers a fourth mode of operation, whereby superconducting turbine generators in the shaftless core, function off the combustion exhaust to rotate them at very high speed, providing large amounts of electrical power to electromagnetically charge a series of superconducting core rings which run down the length of the common flow path tunnel acting like a pure electric rocket, and charge hydrogen fuel, yielding a hydrogen isotope, a helicon derivative, in natural abundance in the hydrogen fuel and in the atmosphere. On the exterior of the common flow path tunnel, to accelerate the diluent exhaust coming from the scramjet diffuser aft of the radial combustor around the tunnel to accelerate the flow to hypervelocity speeds, the hydrogen yield to the hydrogen isotope, helicon, supports the accelerated flow of exhaust through a radial diffusing nozzle or rocket nozzle, out of the tunnel, inboard of the ram-scram combustors. It is fed in portion from them, as well as by inlets from around the aerospike (achieving exhaust flight speeds in excess of Mach 20). The preferred embodiment of HYPERDRIVE receives all its thrust from the air breathing turbines from the roll out of a horizontal runway launch to about 1.00 kilometers per second (2600 mph) up to 150,000 ft. altitude. It uses about 70% of the thrust from air breathing ramjets combined with turbine operation from 1.00-3 klm/second (2600-6700 mph). It then uses about 50% of the thrust from air breathing scramjet mode up to 48 kilometers altitude, then switching over to 100% electromagnetic plasma yield helicon hydrogen drive thrust, combined with rocket turbines for powering the air compressor or the liquid oxygen pump dumping the hydrogen out of injectors by the ram-scramjet ramps, to achieve orbit at 100 km in part a gaseous thrust state, and in part an electric thrust drive state. The acceleration phase is designed to be so rapid, that HYPERDRIVE can begin coasting as it runs out of air, transition on helicon hydrogen in the superconducting plasma accelerated tunnel, to operate at around 40 kilometers with significant gain in altitude to achieve its 100 km low earth orbit.

A multi-variable cycle engine comprising of a common flow path tunnel sized to accommodate subsonic thrust and bypass air, supersonic core compressed air for combined cycle radial ram-scramjet propulsion, supersonic superconducting electromagnetic hydrodynamic plasma drive (ionized air) and hypervelocity (above Mach 10) ionized plasma propulsive thrust for hypersonic flight regimes using a radial scramjet configuration surrounding the common flow path tunnel. For crossing the difficult high supersonic to low hypersonic flight regimes and sustaining engine combustion going from subsonic compression with mechanical rotating turbomachinery to supersonic compression in a ram-scramjet compression between Mach 3.5 and Mach 5.0 a series of superconducting shaft core segments generating large amounts of electric power sustain high electromagnetic field conditions and propulse plasma ionized air mass flow and fuel across the ram-scramjet dual more combustor external to the subsonic turbine combustor, offering both hydrocarbon plasma fuel and ionized hydrogen fuel (hybrid fuel condition) for increases in specific impulse power of the engine, with conditions which allow it to ascend on a single stage to orbit (SSTO) space plane or rocket jet, by incorporating the electric field charge into the effluent flow of both bypass air, core supersonic flow air and hypersonic atomized air (plasma fuel) in the ram scramjet combustor where it is combined molecularly with fuel.

The common flow tunnel has an aerospike ram which is actuated in a linear fashion to accommodate the amount of air flow into the tunnel dependent on the flight condition (subsonic: Mach 0.0 to 1.0; supersonic: Mach 1.0-Mach 5.0; hypersonic: Mach 5.0-25.0) and to position its 3D compression ramp geometry which determines supersonic compression through creation and positioning of shock waves and subsequent shock trains, where dependent upon its position the aerospike can allow for inlet air to reside in a subsonic combustion chamber to the outside of the tunnel, or it may allow for air to enter directly into the exterior outer exoskeleton section of the engine where the ram-scramjet combustion takes place, bypassing the subsonic combustion core combustor, compressed supersonically forming the shock trains for compression. Hence as a pressure and temperature rises, gas aerodynamic devices such as the aerospike, offers smooth transition speeds for combustion across the subsonic, to supersonic, to hypersonic combustion, aided by the aerospike. When the aerospike is in the forward position, inlet air approaches the subsonic combustion path being compressed by a plurality of electromagnetically core driven compressor blades and trunions for the low bypass (for thrust at sea level for takeoff at ISO conditions) thrust, the compressor blades circumferentially surround the common flow path tunnel completely integrated to the segmented superconducting power shaft core described in corresponding application Ser. No. 14/209,880, and compress the air to a sufficient pressure and temperature for combustion in the subsonic combustor with exhaust into the turbine. When the aerospike is in the rearward position inlet air enters through a different inlet section along the common flow path tunnel and occurs at speeds starting at Mach 3.5-5.0 so that the inlet air is compressed in the exterior ram-scramjet dual mode radial common flow path tunnel supersonically prior to reaching the diffuser and combustor for hypersonic MHD combustion drive, versus the core ring geometric structure of the subsonic combustor at the perimeter of the common flowpath tunnel, but of which shares in part the flow path from the aerospike, and the high speed inlet air for supersonic combustion and the low speed air of subsonic combustion. HYPERDRIVE provides a method where subsonic physical/mechanical compression using magnetically superconducting cons driven compressor blades is shared with high velocity shock train compression as in scramjet combustion simultaneously assisted by MHD and plasma combustion (electrified by power from the superconductors) in the subsonic flow of the low speed combustor exterior, to the bypass air tunnel, core, and the high speed supersonic and hypersonic ram-scramjet combustor and ramp, during the difficult transition point from high speed supersonic flight, Mach 3.5, to low speed hypersonic flight, Mach 5.0.

The common flowpath tunnel also serves as a superconducting electromagnetic accelerator, or a magnetic thrust chamber, where charged air or hydrocarbon feel particles in a plasma state are accelerated as gas combustion discharges, and provides high specific impulse power for space flight in the order of 500-1000 lb. fuel/sec.-lb.thrust, also Isp. In space or tens of thousands (10,000)—to hundreds of thousands (100,000 lbs.) of thrust/hour/lb. of fuel burned in the atmosphere. The common flowpath tunnel serves the purpose in ramjet/scramjet mode to deliver air either as a ram compression constituent (high subsonic ram) or as supersonic ramjet combustion air-scramjet mode, whereby the velocity of the air is so high, that as the common flowpath tunnel tapers and gets narrower in three dimensions (a 3D tunnel versus the typical 2D tunnels of scramjets) it compresses the air through the formation of shock trains, and compression of those shocks along specific points of the tunnel based on the geometric angles of the tunnel as it narrows occurs.

The common flowpath tunnel serves as a magnetic thrust chamber due to the high Tesla magnetic field created by the superconducting rings placed at specific stages down the length of the tunnel in order to accelerate the plasma flow exhaust as it is charged coming aft of the combustor. The superconducting plasma rings are first in place for rotating the compressor blade stages for mechanical compression in lower speed flight, i.e from Mach 1.0 to Mach 3.5. Once achieving this speed, the electric compressor can be shut off electrically as the engine turns to ram-scramjet mode. The superconducting plasma rings, which act as superconducting generators in the 5-stage turbine core, generate power from the extraction of kinetic energy from the gas flow from the lower speed subsonic-supersonic combustor. The outer plasma core superconducting rings simultaneously serve as plasma accelerators based on their ability to store power and displace electric energy to accelerate charged air flow in the superconducting ram compression tunnel for very high speed flight during pure scramjet operation above Mach 6.0, the 4^{th} engine cycle as the engine system transitions into rare air space, above 35 to 40 km. The high velocity exhaust stream generated from the combustion and expansion of ionized air in the tunnel the hydrocarbon or hydrogen fuel is electrically ionized by an electromagnetic charge at the ejectors in the 3D combustion chamber. The combustor chamber serves a dual use, both in subsonic/supersonic regimes, and in the hypersonic regime when entering a non air-breathing space environment and HYPERDRIVE relies on space plasma drive combustion and electromagnetic hydrogen ion acceleration. The combustion chamber is located about halfway down the length of the common flow path tunnel and circumvents the perimeter of the tunnel, whereby its volume expands to create a diffuse in front of the combustion point, the flame holder and electromagnetic plasma creating fuel ejectors which charge the fuel in the engine.

The combustion chamber expands dimensionally in volume to diffuse the velocity of ram air or scramjet airflow by increasing the internal dimensions so as to increase residence time for combustion. A constant magnetic flux zone that moves with the charged hydrocarbon particles in a constant traveling wave, the superconducting rings operate in persistent mode, and are used as a conducting source to propel the high Mach stream plasma down the tunnel, accelerating it beyond its advancing combustion state from the scramjet combustor. The constant flux synchronous motor of the common flowpath tunnel developed by the plasma superconducting rings delivers the required propulsion forces for the ionically charged hydrocarbon or hydrogen combusted exhaust stream without producing any significant charge reduction eddy currents. To avoid inducing any significant eddy currents the accelerator coils need to see an almost constant magnetic flux during their operation for the hypervelocity phase (Mach 10+) of the high temperature superconducting compound, magnesium diboride, which provides high current and Tesla capabilities in the core superconducting accelerator of the charged scramjet exhaust effluent, which is also simultaneously the common flow path tunnel. The exhaust effluent is constantly charged inductively with a DC current either from the superconducting ring turbine generators on the exterior of the core creating power from the 5-stage turbine core (also the plasma ring generators on the interior of the tunnel core) operating during turbine operation for thrust during the subsonic and high supersonic phases of flight (Mach 1.0 to Mach 3.5) or charged by the superconductor energy storage devices (plasma ring generators) integrated into the HYPERDRIVE system aft of the combustor in specific ring arrays, adjacent to the superconducting turbine ring generator, when space flight propulsion is required and achieved above Mach 10.0 as a non-airbreathing propulsion system. Since the hydrogen fuel used is kept at very low temperatures, it can be used to not only help cool the engine as a whole but also to keep the superconducting materials within the superconducting magnets around the common flow path tunnel at proper operating temperature.

The primary objective of HYPERDRIVE, the invention, is a thrust producing aerospace propulsion engine with maximum average specific impulse (ISP) from sea level to low earth Orbit (LEO) and/or geosynchronous orbit (GSO) above 1000, or in excess of 800,000 lbs./thrust/per pound of fuel/per hour. The ISP is the pounds of force of thrust per pound of fuel burned per second. Another objective of the invention is to have an engine with the maximum thrust to weight ratio (T/W) possible. in terms of space propulsion systems, this is in excess of a 12:1 ratio, thrust being 15 times the weight of the engine. A further objective is to have the engine be a multiple engine cycle design incorporating both 1. Subsonic air breathing (gas turbine), 2. Supersonic air breathing (scramjet), 3. Ion-turbo-rocket (plasma turbo ramjet), 4. Pure non-airbreathing rocket (liquid hydrocarbon fueled rocket), 5. A high power electromagnetic plasma drive propulsor combining rocket and magnetohydrodynamic drive physics combustion. This is not typically categorized, but may be as closely defines as a multiple hydrocarbon-electric plasma fueled combined cycle engine, or magnetic hydrocarbon plasma rocket; with the innovation of the plasma rocket embedded in an exoskeleton chassis consisting of a radial geometric orientation of multiple scramjets with a superconducting electromagnetic accelerator tunnel for central common flow path. The combined turbine scram-ramjet, rocket and plasma drive joins multiple propulsive systems to achieve single stage to orbit capability. Other specific objectives will become apparent from the combination of the drawings and detailed descriptions of the drawings.

HYPERDRIVE provides a number of central technical and structural concepts for being novel and unique in the arena of sustained hypersonic space flight involving a combined hybrid space engine cycle flowpath, to improve propulsion system performance from takeoff on a horizontal runway to space at low earth order, at approximately 100 kilometers, and return to a similar runway integrated into a space plane configuration, describing a single stage to orbit (SSTO) vehicle. In essence HYPERDRIVE integrates into a common flowpath variable engine cycles based on a turbo-ram scramjet plasma rocket engine cycle architectures with accelerated ion plasma drive from a superconducting tunnel which is one in the same as the common few path when the engine is an airbreather at the launch phase of the flight (the tunnel acts as a supporting structure for the superconductors and feeds bypass air to the internals of the engine). The engine architecture is such that from acceleration phase as an air breather with sustained acceleration to Mach 6, then acceleration through to Mach 14, to low earth orbit across this broad Mach number spectrum from static launch conditions on the runway is possible to high hypersonic speeds at extreme altitudes as a hybrid common flowpath rocket. An object of the present invention is to provide an improved propulsion system having a capability to provide boost and sustain thrust efficiently over a broad Mach number spectrum from static conditions at launch to hypersonic speeds at extreme altitudes (above 130,000 feet). The HYPERDRIVE propulsion system is a variable geometry (engine inlet folds and articulates to move mass flow air into interior or exterior of the engine, as well as adjust the position of the shock waves upon the inlet lip or ramp —internal versus external compression) at both the front Inlet section of the engine, as well as at the aft end of the engine (the nozzle articulates to accommodate plasma acceleration, ionic charge, and sustainment of ionic charge and electromagnetic propulsive forces).

It is another object of the engine and its invention is to provide a fully integrated single stage to orbit and system in a space plane vehicle.

If is yet another object of the invention to provide a multi-engine air-electric-plasma fueled, multi-propulsive engine cycle consisting of: subsonic thrust and bypass air via jet fuel, supersonic core compressed and gas combusted air using hydrogen, combined cycle radial ram-scramjet propulsion from electric ion plasma and hydrogen, and supersonic superconducting electromagnetic hydrodynamic plasma drive from superconducting shock accelerator tunnel.

The HYPERDRIVE invention is a turbo-ram scramjet plasma rocket engine with live engine cycles, using simultaneously, dependent on what flight phase it is operating in, both a kerosene based fuel, a hydrocarbon based fuel, a hydrogen ion plasma generated fuel and a drag reducing/thrust building propulsion system for high speed ascent propulsion phase, all within the same engine architecture in the flight vehicle, thereby allowing multi-engine combustion and drag reduction systems, providing fuel and oxidizer mixtures over a wide Mach number operating range, and thus capability of single stage to orbit operation. There is a central combustion chamber aligned in parallel with the superconducting bypass compression mass flow tunnel which approximately spans 60 inches across. The combustion chamber has two distinct structural designs, one inboard, inside the tunnel, and one outboard the compression tunnel. Of the outboard combustion chamber laying outside the tunnel, it has two distinct physical architectures. A low speed subsonic air combustor, and the high-speed, supersonic air combustor are adjacent to one another and in parallel with articulating gates for the mass flow to enter according to the flight Mach number realized. The low speed combustor is provided mass flow air from the electric superconducting compressor ahead of it, via mechanically compressing the air with compressor blade arrays located in stages down the length of the engine ahead of the combustor. The high-speed combustor, adjacent to it, relies upon supersonic compression of air through a circumferential ram tunnel ahead of it, parallel to the superconducting electric compressor, and outboard of it. The circumferential compressor tunnel forms back end the superconducting shock tunnel for plasma accelerated MHD exhaust drive, and serves as the ram-scramjet compression tunnel for a series of scramjet assemblies defined in architecture radially about the superconducting bypass air, shock and compression tunnel at the center of the engine. The superconducting plasma tunnel houses the circumferential superconducting electromagnetic ring(s) which have a dual use in both providing multi-megawatts of electric power to the engine (they run when transitioning across high Mach numbers the superconducting plasma accelerator, and/or MHD drive for above Mach 8-10 acceleration beyond the atmosphere with air, toward low earth orbit, and also acting as accelerator rings for upstream charged mass airflow from the MHD charge/drive at the inlet, to flow downstream providing pure high Mach plasma propulsion.

To get airborne off a runway integrated into an air vehicle without a carrier aircraft or rocket booster (which today is the bane of scramjet technology) the engine of invention incorporates a moderate pressure ratio, with high through flow axial compression utilizing a high-speed twin electric bypass fan, a superconducting compressor, and central superconducting plasma compression accelerator driven hollow shaft core in a multi-engine cycle exo-skeleton engine shell. This leaves the central core of the engine to house a 3-dimensional core compression inlet and ramp for hypersonic speeds, assisted to very high near space Mach numbers by the plasma accelerator and MHD plasma assisted drive. At high freestream Mach numbers, above Mach 5.0, when the hypersonic combustion flowpath may be ignited, the compression ratio of the fan is no longer needed, and because it is driven as an exoskeleton structure electromagnetically, its survivability in very high Mach number (where rotating highly alloyed metals in the form of compressor blades would not survive the thermal aero and electrodynamic heating) environments, from very high stagnation temperatures with captured air in the compression tunnel is not in question, as rotating electric turbomachinery can be switched off. Consequently the fan and compression stages may the retracted, covered up, as removed from the shared common flowpath, both interior to the tunnel and exterior to the ram-scramjet, plasma rocket, and therefore the central tunnel may be utilized above mach 5.0 for successful and sustained supersonic compression, and hypersonic plasma electric thrust.

### BRIEF DESCRIPTION OF THE DRAWINGS

FIG. 1 is a side view of a simplified representation of the Radial Vortex Plasma Field.

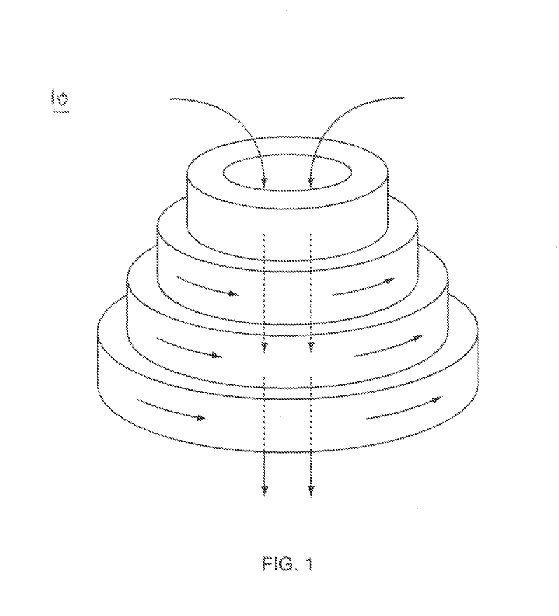

FIG. 2 is a side view of the present invention and an accompanying equation.

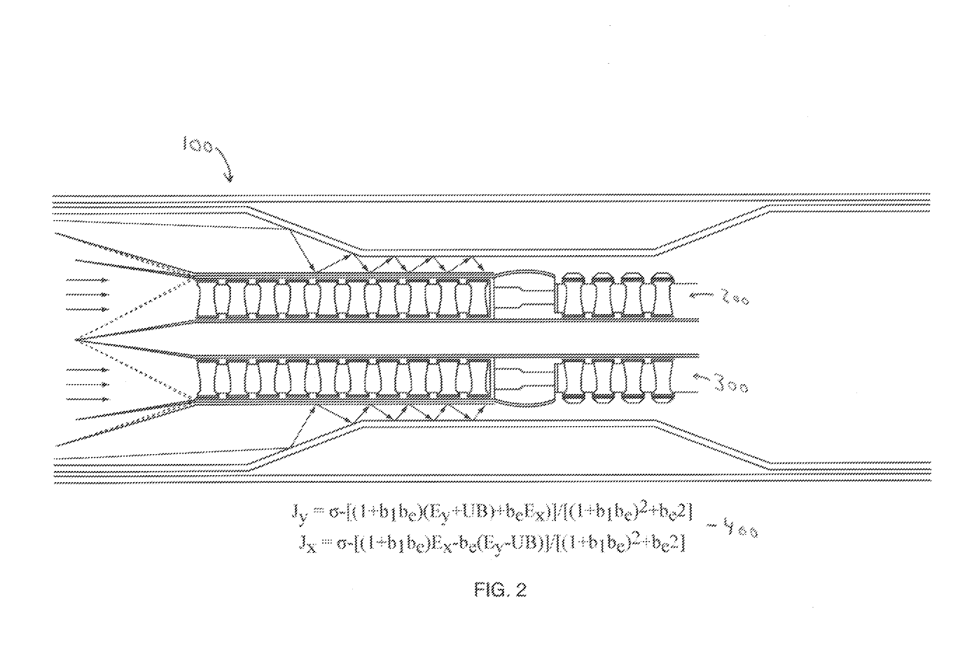

FIG. 3 is a perspective view showing a portion of the drive engine of the present invention.

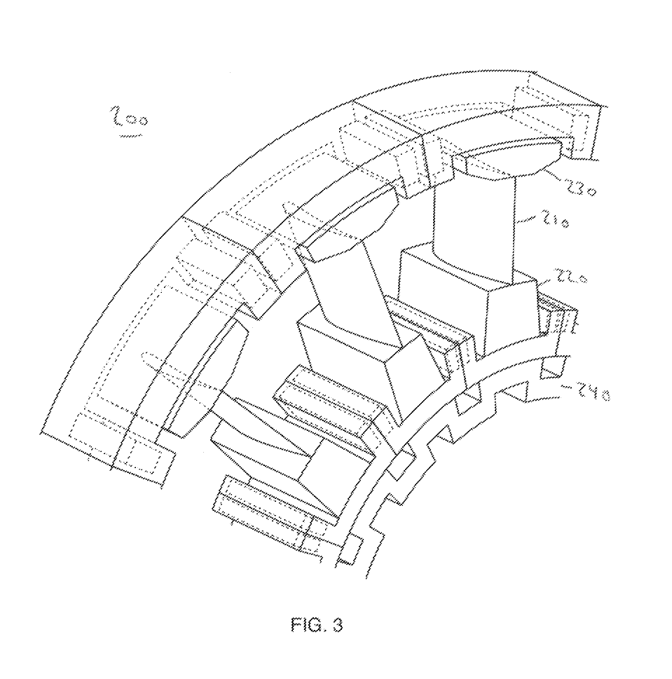

FIG. 4 is a side view of the Radial Vortex Plasma Field of FIG. 1, showing the charge orientation.

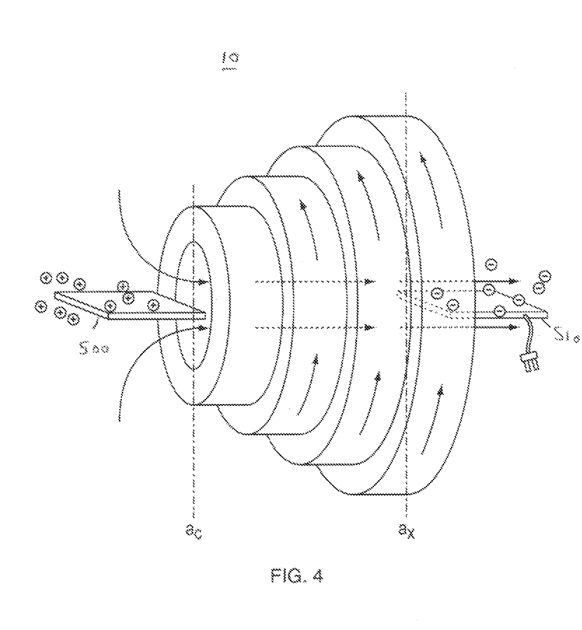

FIG. 5 is a top perspective view of the engine of the present invention and showing a single representation of a stator.

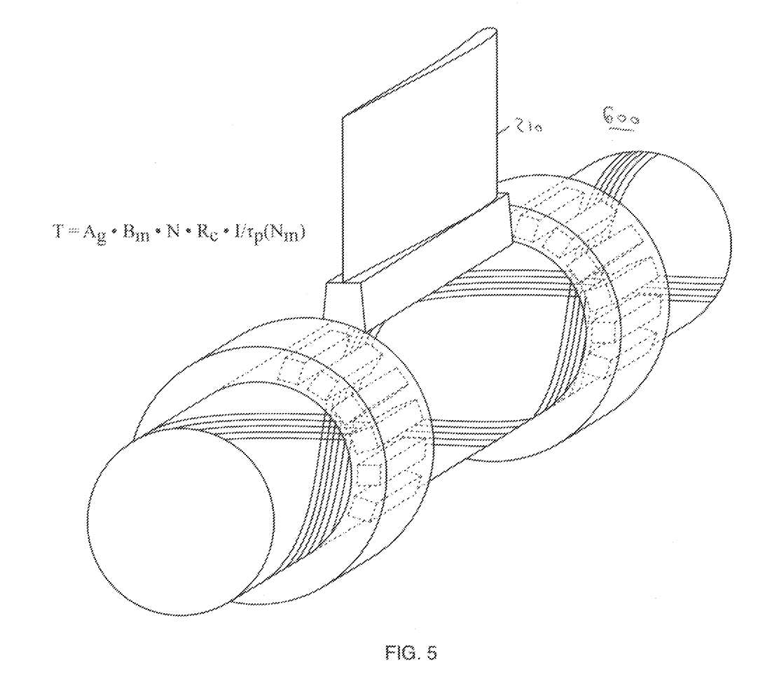

FIG. 6 is a first set of equations used in determining drive conditions.

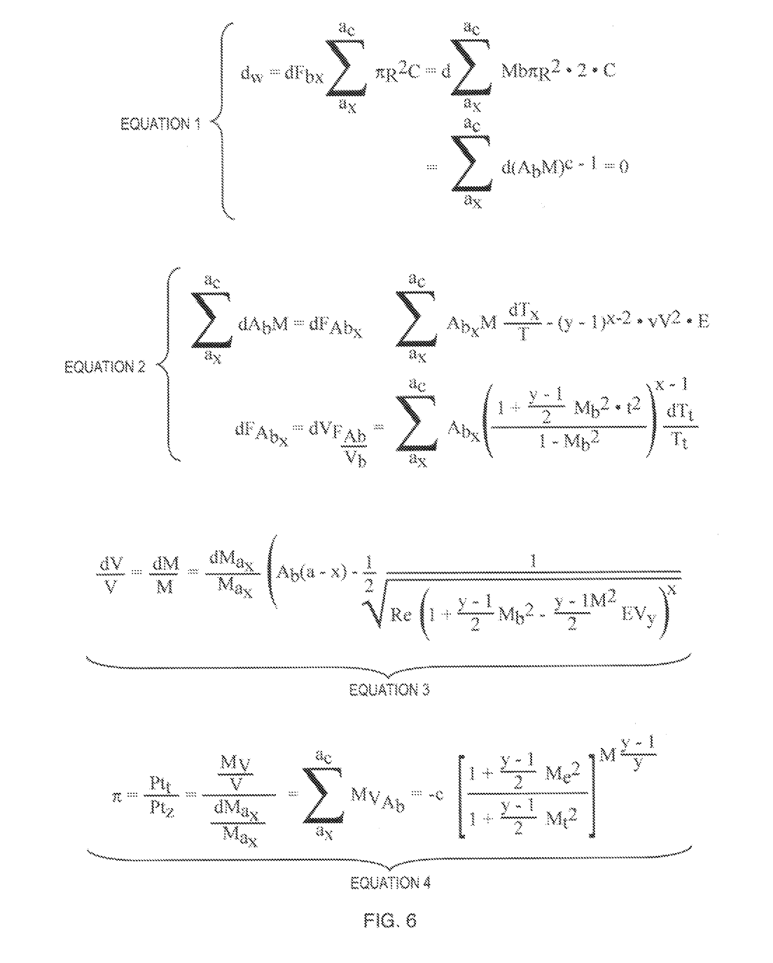

FIG. 7 is a second set of equations used in determining drive conditions.

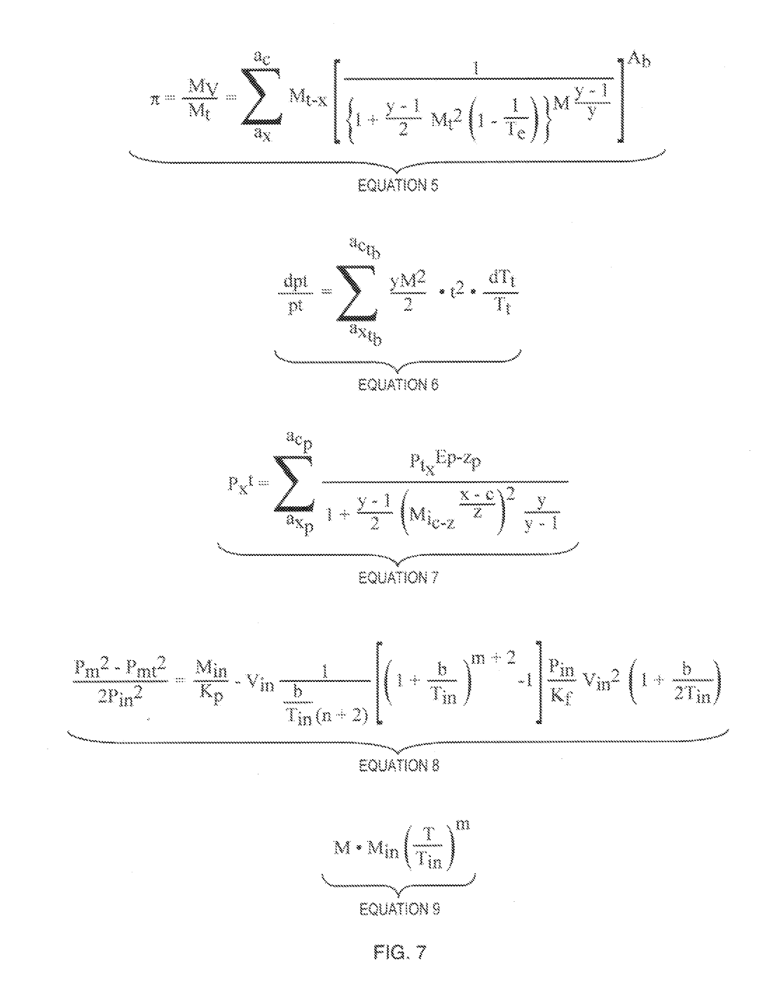

### DETAILED DESCRIPTION OF THE INVENTION

Real progress in understanding and the control of hypersonic flows and hypersonic air breathing engines, combined with a superconducting axial and Normal vector flow field at the HYPERDRIVE core (combustor location) at sufficient magnetic flux density and ionization power, eventually rests upon the derivation of novel and unique analytical methods, and mathematical modeling so as to forecast predict, and compute their behavior. The combining of the ram-scramjet dual mode use combustor technology, and high “Tesla” field rotating Normal (vector) and axial magnetic flow fields to power and catalyze combustion across multi-phase combustion, Mach number flight conditions, has not been done before, and is novel and unique. The following mathematical equation analysis is the objective study of such a multi-Mach number, multi-engine cycle hypersonic space scramjet called HYPERDRIVE. The essential core innovation in HYPERDRIVE is the superconducting powershaft core SPSC fully integrated into MHD power shock propulsive tunneling feeding ionized air across a Mach 3.5 to Mach 4.5 range flow, into the HYPERDRIVE ram-scramjet dual mode combustor. Diagram B depicts the first turbine stage aft of the turbine low-speed combustor (Mach 1.0-Mach 3.5) which provides superconducting electric power from the SPSC to the dual mode/dual, use ram-scramjet combustor, fed by ionized mechanical compressed air from the electric segmented compressor

Diagram A: Radial Vortex Plasma Field, Normal Flow Field runs axially down the center, SPSC Vector field flow runs out tangent to the radial superconductors presenting toroidal magnetic field containment, this is generated by rotating turbine thrust superconductors against the SPSC hollow core shaft. Equation of State describes energy generation and equilibrium of HYPERDRIVE MHD and power generation, and plasma thrust and acceleration, both with inviscid flow (Euler Equations and with viscous Navier Stokes Equations), and energy equations of state. Guiding center hybrid equation for Ohm's Law MHD generator in HYPERDRIVE is Equation 1A in the Y axis, and Equation 1B for the X axis.

Diagram B: HYPERDRIVE Engine Profile: From outboard to inboard and to center line axially in profile; scramjet radial engine, ramjet turbine hybrid profile, articulating aerospike forward of inlet lip, inlet lips including internal 1^{st} and 2^{nd} compression ramps for hybrid scramjet profile, common central tunnel core with outboard rotating turbomachinery, outboard of this hybrid ram-scram turbine combustor (high speed) and turbine combustor adjacent (low speed), eleven stage superconducting electric compressor and five stage superconducting turbine core. HYPERDRIVE in profile exhibits an exoskeleton in conjunction with the shaftless architecture of which the hollow shaft core acts as a cooling conduit for air.

A Hybrid method using a field evolution equation derivative momentum equation replaced by “bulk fluid” MHD, with a kinetic equation displaced at the point of before the combustor ramp Ax, and slope of “theta”, at the combustor and pre-ramp combustor slope, theta-C therefore Equation 1C, stating that “ions are the particles obeying guiding center hybrid equations of state and energy”.

Equation 1C defines a hybrid equation model follows a nonlinear interaction of energetic particles where momentum force Change, V across resonant MHD waves, beginning at combustor ramp r1, and propagates to r2, at acceleration rate and momentum equation 1C.

With derivative closure, the momentum equation for MHD drive is translated to 1D, a derivative continuum equation defining electromagnetic momentum of the MHD waves from r1 to r2.

The Hall parameter for ions, I, and electrons e, the momentum collision delay time is Ti for ions and electrons. Electrical conductivity is expressed as 1D−a, where Ne is electron density. Electron density of the MMD, guided by Ohm's Law equations, 1A and 1B, and the Hall Parameter, which are related through the magnetic field. The Ohm equations describe the magnitude of the MHD accelerator at “alpha x”, aft of “alpha y”, with the combustor inlet at hybrid inlet ram-scram operation between Mach 1.0 to Mach 4.0 transition, defined by equation 1E.

Ne is electron density. It is noted that the electrical conductivity and Hall parameter are related through the magnetic field, B1, and electro density. This equation is a general equation for an electrode in HYPERDRIVE of configuration for both a generator and an accelerator.

Diagram C: Normal field in HYPERDRIVE is 90 degrees out of plane and is toroidal. Vector flow field of ionization across the ram-scramjet combustor operation from ramjet mode is at an angle “theta”, with a notional beginning and end of the HYPERDRIVE superconducting tunnel where MHD takes place formed from Ac to Ax, with the axial field down the length of the engine.

The Normal field perpendicular to the toroidal flow of the superconducting flow path can act as a propulsor in space, given an ionizing gas under pressure, such as zeon, thus forming an “MHD Drive Accelerator”, with power being pulled off the drive plate (Diagram C)

In the case of HYPERDRIVE, the cross How of the Normal magnetic field, may be used electromagnetically, to transition, start, and sustain scramjet combustion at the outer core, powered by the strut superconductor from SFSC as to sustain ignition above Mach 4.5 of the radial hybrid scramjet vector architecture which is HYPERDRIVE.

High electric power may act as a catalyst to sustain combustion, in terms of controlling residence time in the dual mode combustion system, radially arranged around the hypersonic turbine, superconducting compression tunnel core (hydrogen, hydrocarbon, JP-7, superconducting zeon gas), via an arrangement of electrodes embedded in each combustor ramp respectively, powered by each superconducting strut (structural member that separates each ram-scramjet plasma accelerator ramp), coming off the superconducting power shall core (SPSC) in the HYPERDRIVE Engine.

Taking a macroscopic approach where torque is related to winding hack EMF through the use of conservation of energy principles, a general torque expression for a motor/generator can be expanded as Equation 2.

Equation 2 defines where Ag is the cross-sectional area air gap, Bm, and it is the air gap flax density created by the magnets, and Ne is the number of turns, I is the rated winding current, Tp is the pole pitch (Diagram E).

In maximizing electric and magnetic loading, it is assumed that a frictionless flow is present to a constraining radius to a point of compression from structural landmarks in the HYPERDRIVE engine architecture, Ac to Ax, as a constraining radius, so described in the “Summarization Derivative” (Equation 3).

That the constraining radius from Ac to Ax changes over time to a design point of Mach 4.5, the constraining radius of the Superconducting Power Shaft Core previously, is defined here between the axial radius at this point in the core, Ac, at the electromagnetic rotating compression for the ram-scramjet, and dual combustion point herewith, and then pure scramjet operational point. The equation summarizes the electromagnetic and thermodynamic forces present, resultant to the point of combustion, at the first and second point of the scramjet ramp, catalyzed by M, at the radius R, with cross-sectional area A, at this constraining radius Ax, and force vector of magnetic flux, and compression efficiency C.

At the above point in technical subject 13, above, mass flow constraining radius of compression must be equal between mechanical compression, ram-scramjet compression, pure supersonic scramjet compression, hypersonic superconducting ion plasma compression-acceleration, therefore through substitution we have Equation 4.

Equation 4 is simplified and integrated to yield a differential equation linking total temperature to total compression. Including electromagnetic heating influence through convection, to total Mach number, which is found across mass flow constraining radius, Equation 5.

It is noted that the Mach number in Equation 5 decreases steadily with heating on energy addition (total temperature increases) and passes continuously through as a sonic condition. The slope of the curves for function summary is a function of Mach number, and increase with heating and rise in compression, and enthalpy. This is due to the follow-on integrated compression ratio summary from Ac to Ax, as a function of pressure, tied to Mach number, at any precise radius along the HYPERDRIVE powershaft core, and the function becoming the integrated summary function, Equation 6.

The total heating loss in HYPERDRIVE is critical to understand as it is the combination of both combustion and electric cycles, and the electric component adds energy through convection and heating, it can be expressed as a Raleigh heating number in Equation 7 within the constant changing radius of the HYPERDRIVE ram-scramjet tunnel and superconducting accelerated plasma flow corridor, one in the same, from Ac to Ax, within the throat of the tunnel between mechanical compression (axial compressor blades) and supersonic compression, and consequential combustion, upward from Mach 3.3 toward Mach 4.5

Total, compression again decreases with increased heating (or total temperature), and more rapidly, as the inlet to the throat of the compression ramp behind the articulating compression ramp aerospike observes flow Mach number increases.

Equation 8 leads to similarity between Ac to Ax of the ram-scram MHD electromagnetic compression ramp, with a constant area of heating, and is shown as total pressure, which can never fall below Summary Pressure equation 9.

In all thermodynamic and some electric heating plasma arc engine systems higher operating temperatures lead to higher pressure drops, both in the HYPERDRIVE dual mode combustor, and down stream where it is not wanted, effecting total propulsive thrust, Isp. This association is directly connected to non-isothermal temperatures within the segmented walls of HYPERDRIVE in the architectural geometry of the ram-scram combustors and diffusers separated by these walls (Diagram E) This is in effect segmentation between each radial flow-path, and each scramjet combustor ramp.

The wall, along with the cryogen hydrogen fuel coolant is lower in temperature, therefore local flow thru velocity is higher, yielding to a higher differential pressure drop originating from viscous forces. A thermal equilibrium is assumed at the scramjet/turbo-ramjet walls, with the cryogen coolant (hydrogen) acting as a linear temperature isolator measured as a hot gas convection/conductive heat sink

The Darcy-Forcheimer Equation, equation 10, is well established phenomenologically derived constitutive equation that describes the flow through a conductive medium, as in hydrogen in HYPERDRIVE, acting as a conductive heat sink and thermally managing the temperature of the porous walls during combustion in a ram-scramjet injector ramp. This is the first time for this and is novel and unique to HYPERDRIVE. The ramjet pressure gradient from compression of mass flow, combined with the scramjet pressure gradient across a significantly larger Mach number is only achievable through a porous segmented wall of the combustor section of the ram-scramjet in HYPERDRIVE. Equation 10 is modified to accommodate the broader heat gradients of this “hybrid hypersonic combustor”, utilizing porous metal matrix ceramic walls, in the segmentation of one ram-scram combustor section from another, in radial fashion, around the circumference of the HYPERDRIVE engine.

The modified mathematic derivation of the Darcy Equation, accommodates the heat gradients, cooling and distribution of the hydrogen through the porous walls with cryogen hydrogen fuel, creating the required differential pressures and cooling across the ram-scramjet ramps and injectors. The pressure drops that are high from high temperatures operating at combustion point of thermally stabilized cryogenic hydrogen, through a porous, radial, dual mode, ram-scramjet combustor, as in HYPERDRIVE, is unique and novel. in the modified Darcy Equation described where the viscosity is temperature dependent following the Power Law as in Equation 11, where flow through results are compared to the modified Darcy Forcheimer Equation with CMC porous walls in the ram-scramjet combustor region in HYPERDRIVE, noting that pressure drop maybe plotted against flow through. The region of the ram-scram combustor and its walls is most important, because it is neither desired to reach full-cooling of the wall, nor is it possible to exceed the maximum bearable temperature of the wall material.

What is claimed is:

1. A turbo-ram scramjet plasma rocket engine with five engine cycles, using simultaneously, dependent on what flight phase it is operating in, both a kerosene based fuel, a hydrocarbon based feel a hydrogen ion plasma generated fuel, and a drag reducing/thrust building propulsion system for high speed ascent propulsion phase, all within the same engine architecture in the flight vehicle, thereby allowing multi-engine combustion and drag reduction systems, providing fuel and oxidizer mixtures over a wide Mach number operating range, and thus capability of single stage to orbit operation.

2. The engine of claim 1 further comprising a central combustion chamber aligned in parallel with the superconducting bypass compression mass flow tunnel, wherein the combustion chamber has two distinct structural designs, one inboard, inside the tunnel, and one outboard the compression tunnel.

3. The engine of claim 2 wherein the outboard combustion chamber laying outside the tunnel includes a low speed subsonic air combustor, and a high-speed, supersonic air combustor are adjacent to one another and in parallel with articulating gates.

4. The engine of claim 3 wherein the low speed combustor is provided mass flow air from the electric superconducting compressor ahead of it, via mechanically compressing the air with compressor blade arrays located in stages down the length of the engine ahead of the combustor.

5. The engine of claim 4 wherein the high-speed combustor relies upon supersonic compression of air through a circumferential ram tunnel ahead of it, parallel to the superconducting electric compressor, and outboard of it.

6. The engine of claim 5 wherein the circumferential compressor tunnel forms back end the superconducting shock tunnel for plasma accelerated MHD exhaust drive, and serves as the ram-scramjet compression tunnel for a series of scramjet assemblies defined in architecture radially about the superconducting bypass air, shock and compression tunnel at the center of the engine.

7. The engine of claim 6 wherein the superconducting plasma tunnel houses the circumferential superconducting electromagnetic rings(s) which have a dual use in both providing multi-megawatts of electric power to the engine.
